(19) United States
(12) Patent Application Publication
(10) Pub. No.: US 2007/0086372 A1
(43) Pub. Date: Apr. 19, 2007

(54) Method and system for ubiquitous license and access using mobile communication devices

(75) Inventors: Yong C. Lee, Miramar, FL (US); Dominik Buszko, Weston, FL (US); Robin I. Lee, Miramar, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/252,908

(22) Filed: Oct. 18, 2005

(51) Int. Cl. H04Q 7/00

(52) U.S. Cl. 370/328

(57) ABSTRACT

A wireless communication system (100) using a portable license can include a transceiver (102 or 103), a local access point (150) operatively coupled to the transceiver, and a processor (104). The processor can be programmed to receive (304) a license and subscription information over a first network for content available on a second network, and transfer (306) the license and subscription information via a short range communication link to the local access point device to authorize receipt (310) of content on the second network if a network operator for the second network verifies (308) the license. Note, the transceiver can be a part of a cellular phone, a satellite phone, a smart phone, a laptop computer, a personal digital assistant, or a messaging device or other communication device and the local access point can be a set top box or a satellite radio receiver system.

### TECHNICAL FIELD

This invention relates generally to digital rights management, and more particularly to a method and system for granted licenses and access using mobile communication devices.

### BACKGROUND

Users subscribe to service providers that provide content in a limited channel that may be limited to hardware owned by the subscriber or limited to a particular location where a subscriber owns such hardware. Some subscribers would like to have a way to access services or content that they have a right to listen to or view or play without necessarily being limited to a particular user's hardware, but such a solution does not currently exist. For example, a user having subscribed to a cable movie channel on a cable network from a carrier may like to watch a particular show on Sunday nights even though such user might not be near their traditional hardware gateway or their set top box at home. Even when this particular user on a Sunday night is visiting a friend who also has access on the cable network but does not necessarily have a subscription to the particular movie channel currently has no ability to play the content they are technically licensed for at his or her friend's house . Today, there is no way for the user to watch the upcoming episode of the particular show on Sunday nights at his or her friend's place even though he or she has the right to view this program. Obviously this problem exists because the right-to-view is tied together with the location, and more particularly with a set-top-box or SIM card rather than the person who subscribed to the service. Although there are schemes with Digital Rights Management (DRM) that enable many different devices to share the same content, such existing DRM schemes fail to grant right to access subscription to services in a seamless fashion.

### SUMMARY

Embodiments in accordance with the present invention can provide a method of using a license carried on a mobile communication device, a system and a wireless communication apparatus that can enable a user to transfer license and subscription information and to retrieve and play content on a device other than dedicated hardware such as a set to box at a user's home.

In a first embodiment of the present invention, a method of using a license carried on a mobile communication device can include the steps of obtaining license and subscription information over a first network for content available on a second network, transferring the license and subscription information via a short range communication link to a local access point device, and providing content on the second network if a network operator for the second network verifies the license. The step of obtaining the license and subscription information can be done by an over-the-air connection via a WiFi network, a Bluetooth connection, an RFID communication, an infrared link, a satellite link, or a cellular communication link or by a wired communication link. For example, license and subscription information can be obtained by securing and storing information transferred from a set top box into the mobile communication device. The step of transferring the license and subscription information via the short range communication link can be done by transferring the license and subscription information via a Bluetooth connection, an RFID communication, an infrared link, or a wired link. The local access point can be a set top box for example. The method can further include authenticating a user's license and subscription information. The method can further apply digital rights management to protect the content provided on the second network while promoting the sharing of content among users and can block additional content from being provided on the second network if such content is beyond the scope of the license.

In a second embodiment of the present invention, a wireless communication device can include a transceiver, and a processor coupled to the transceiver. The processor can be programmed to receive a license and subscription information over a first network for content available on a second network and transfer the license and subscription information via a short range communication link to a local access point device (such as a set-top box) to authorize receipt of content on the second network if a network operator for the second network verifies the license. The wireless communication device can be a cellular phone, a satellite phone, a smart phone, a laptop computer, a personal digital assistant, or a two-way messaging device among other devices. The processor can be programmed to obtain the license and subscription information by an over-the-air connection via a WiFi network, a Bluetooth connection, an RFID communication, an infrared link, a satellite link, a cellular communication link, or a wired communication link. The processor can also be programmed to transfer the license and subscription information via the short range communication link by transferring the license and subscription information via a Bluetooth connection, an RFID communication, an infrared link, or a wired link. The processor can further be programmed to authenticate a user's license and subscription information, apply digital rights management to protect the content provided on the second network while promoting the sharing of content among users, or block additional content from being provided on the second network if such content is beyond the scope of the license.

In a third embodiment of the present invention, a wireless communication system using a portable license can include a transceiver, a local access point operatively coupled to the transceiver, and a processor coupled to the transceiver. The processor can be programmed to receive a license and subscription information over a first network for content available on a second network, and transfer the license and subscription information via a short range communication link to the local access point device to authorize receipt of content on the second network if a network operator for the second network verifies the license. Note, the transceiver can be a part of a cellular phone, a satellite phone, a smart phone, a laptop computer, a personal digital assistant, or a two-way messaging device or other communication device and the local access point can be for example a set top box or a satellite radio receiver system.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 illustrates a wireless communication system using a portable license in accordance with an embodiment of the present invention.

FIG. 2 is a flow chart illustrating a method of using a license carried on a mobile communication device in accordance with an embodiment of the present invention.

FIG. 3 is a flow chart illustrating another method of using a license carried on a mobile communication device in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

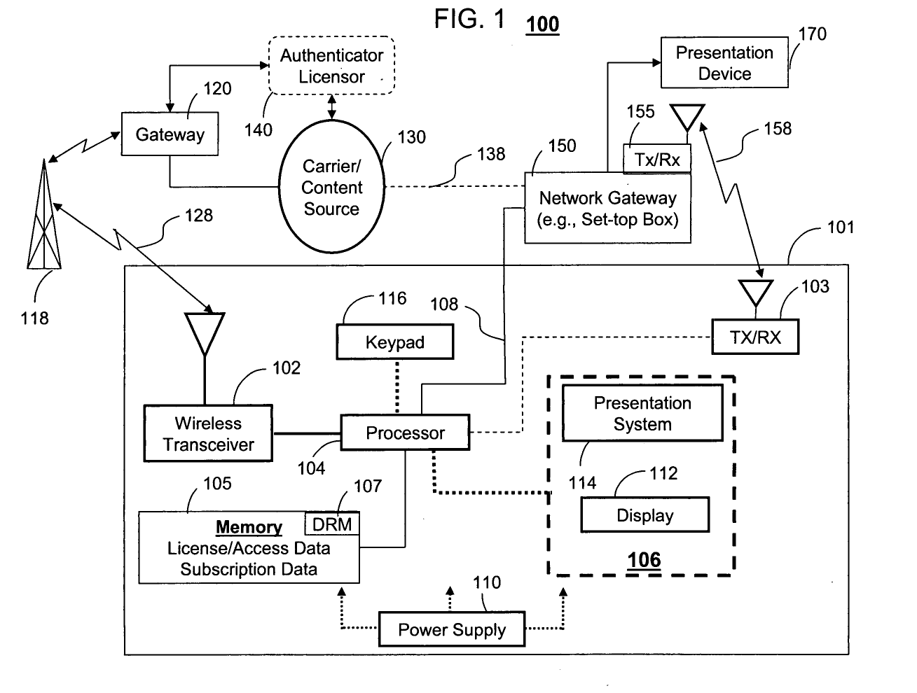

Referring to FIG. 1, a block diagram of a wireless communication system 100 is shown using a portable license in accordance with an embodiment. The license can be carried in a mobile device or a wireless communication device 101 such a selective call receiver or transceiver that can include a transceiver (102 or 103), a local access point 150 operatively coupled to the wireless communication device 101, and a processor 104 coupled to the transceiver (102 or 103). The processor 104 can be programmed to receive a license and subscription information over a first network (128 or 158 or 108) for content available on a second network 138) from a carrier or content source 130, and transfer the license and subscription information via a communication link to the local access point 150 device to authorize receipt of content on the second network if a network operator for the second network (150) verifies the license. Note, the transceiver (102 or 103) can be a part of a cellular phone, a satellite phone, a smart phone, a laptop computer, a personal digital assistant, or a two-way messaging device or other communication device and the local access point 150 can be for example a set top box or a satellite radio receiver system.

The wireless communication device 101 can further include a user interface 106 having a presentation system 114 (such as audio speakers and amplifiers) and a display 112. The wireless communication device 101 can further include a keypad 116, a longer range transceiver (102) such as a cellular transceiver, a shorter range transceiver (103) such a WiFi, Bluetooth, infrared or other suitable short range transceiver, a memory 105 for storing license or access data as well as subscription data, and a power supply 110. The device 101 can further include a digital rights management module 107 which can be part of the memory 105. The wireless communication device 101 can further optionally or alternatively include a data bus, link, or interface 108 for coupling the processor 104 with the gateway 150 in a wired or tethered fashion as opposed to the previously discussed wireless links. The wireless transceiver 102 can utilize existing technology for exchanging wireless messages with a base station 118 over link or network 128 to communicate with a gateway 120. The gateway 120 can be in communication with a carrier or content source 130 or a third party authenticator or licensor 140 that would be able to grant licenses to the owner of the wireless subscriber device 101 on behalf of the carrier 130. Of course, the carrier 130 can perform the authentication and license granting function themselves as well. The wireless technology used can be any wireless technology such as, for example, GSM (Global System for Mobile communication), TDMA (Time Division Multiple Access), or CDMA (Code Division Multiple Access), just to mention a few.

The carrier 130 can provide content to the network gateway 150 (such as a set top box) via communication link or network 138. The network gateway 150 can include or be coupled to a short range transceiver 155 that can communicate with the wireless communication device 101 via transceiver 103 using link 158. The “wireless” communication device 101 can alternatively or optionally receive and transmit requests for licenses and subscriptions from the wireless communication device via the wired link 108 as well. Once the wireless communication device 101 requests, obtains, and transfers the appropriate license and subscription information to the network gateway 150, the desired content can be view at t a presentation device 170. Optionally, the desired content can be viewed on the display 112 of the wireless communication device 101 if the license permits such simultaneous (or dual location (whether simultaneous or not)) viewing. Note, the local access point or gateway 150 can also include media storage in the form of a hard drive, solid state memory, or other memory found for example in personal video recording devices (PVR) or digital video recording (DVR) devices to enable viewing of previously downloaded licensed content and not just viewing of licensed broadcasted content.

The processor 104 can use computing and/or processing such as a microprocessor and/or a DSP (Digital Signal Processor) technology. Additionally, the processor 104 can include media such as RAM (Random Access Memory), DRAM (Dynamic RAM), ROM (Read Only Memory), and/or Flash memory for data processing and storage. The presentation system 114 can use audio technology for intercepting and conveying audible signals to or from a user of the wireless communication device 101. The display 112 can also utilize technology such as an LCD (Liquid Crystal Display) for conveying images to the user with an optional backlight. The keypad 116 can be an input device coupled to the processor 104 for intercepting tactile responses from the user and can also include its own backlight. These responses can be, for instance, tactile responses that represent telephone number dialing for accessing another end user or passwords or account numbers enabling the retrieval of licensed content. Generally speaking, the keypad 116 serves to control operations of the wireless communication device 101

The power supply 110 utilizes energy conversion technology for supply energy to the aforementioned components of the wireless communication device 101. The power supply 110 can be, for instance, a portable battery-operated supply for portable applications of the wireless communication device 101. The processor 104 can be programmed to retrieve and transmit license and subscription data in a number of ways in accordance with the embodiments of the present invention as will be further discussed below. Further note, the aforementioned embodiments of the wireless communication device 101 can represent a conventional cellular phone, a wireless PDA (Personal Digital Assistant), a handheld gaming device, and derivatives thereof.

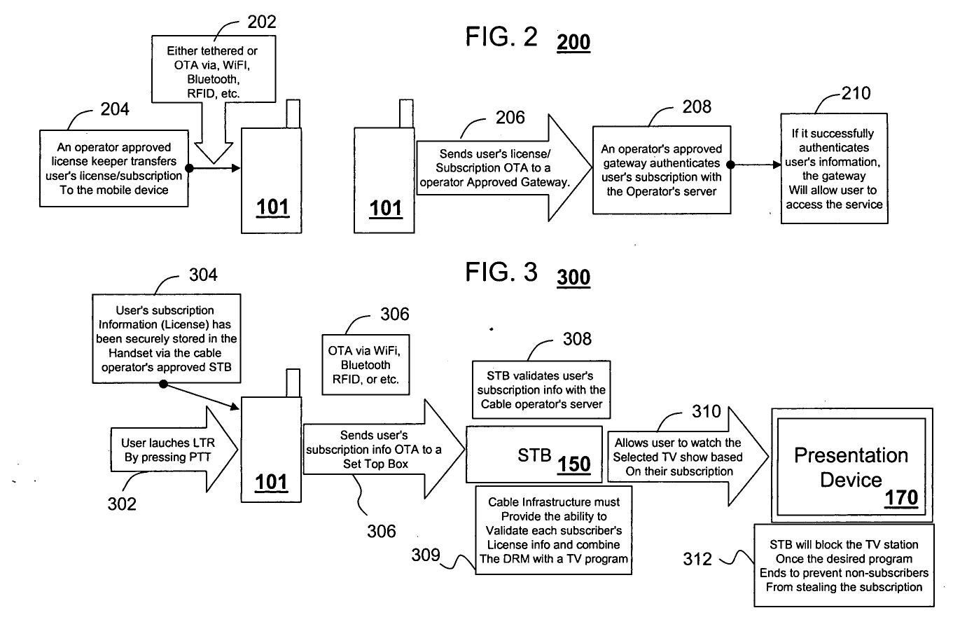

Referring to FIGS. 2 and 3, embodiments herein enable a mobile device such as the wireless communication device 101 to carry a license (or rights) and transfer the personal license information over-the-air (OTA) (or alternatively via a wired link) to allow a gateway 150 such as a set-top-box or other terminal to authenticate the license when the user (of the device 101) wants to access a certain type of content or service. The mobile device 101 being linked via either a wired or wireless link at step 202 to an operator or carrier can receive at step 204 license or subscription data. The user at step 206 can then send the license or subscription data to a carrier or operator approved gateway (e.g., set-top box 150) at step 206. At step 208, the carrier can authenticate the user's license or subscription via the carrier approved gateway. If the license or subscription data is successfully authenticated, the gateway (150) will allow the user of the mobile device 101 to access the desired service or content available through the gateway 150.

In a more specific example as illustrated in FIG. 3, a user of a mobile device 101 having had subscription or license information already securely stored in the mobile device via a cable operator's approved set top box at step 304, can launch a license to roam or license to activate function at step 302 with a push-to-talk or push-to-activate function for example. With a License to Activate a License to Roam function, the user can send the particular desired subscription information that was stored and selected in the mobile device 101 and sent OTA (via Bluetooth, RFID, etc.) at step 306 to a set top box 150 to validate the subscription information at step 308 with the server which is hosted by a cable operator. Upon the validation of the user's subscription information at step 309, the user can choose at step 310 the desired program to watch on the presentation device 170 or just merely download the content for later viewing if the specific license granted allows such actions. Once the licensed program or service ends, the set top box is no longer accessible for unlicensed programming to prevent non-subscribers from misappropriating the subscription at step 312.

Thus, the license to roam or activate function can give a user the ability to carry license on a mobile device combined with the ability to activate a program, content, or service and allow users to access their content or service ubiquitously and seamlessly through a gateway (not the mobile device itself) using a mobile device. Although, the example illustrated involves cable operators, embodiments are not limited thereto and can include using licensing and subscription information on a mobile device to ubiquitously activate content or services on satellite radios, rental cars, passport terminals, telecommunication terminals, automated teller machines, satellite television terminals, PVRs, DVRs, iPODs, MP3 players, among a myriad of other information or entertainment devices that would require a subscription or licensing.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of using a license carried on a mobile communication device, comprising the steps of:
obtaining license and subscription information over a first network for content available on a second network;
transferring the license and subscription information via a short range communication link to a local access point device; and
providing content on the second network if a network operator for the second network verifies the license.

2. The method of claim 1, wherein the step of obtaining the license and subscription information is done by an over-the-air connection via a WiFi network, a Bluetooth connection, an RFID communication, an infrared link, a satellite link, or a cellular communication link.

3. The method of claim 1, wherein the step of obtaining the license and subscription information is done by a wired communication link.

4. The method of claim 1, wherein the step of transferring the license and subscription information via the short range communication link comprises transferring the license and subscription information via a Bluetooth connection, an RFID communication, an infrared link, or a wired link.

5. The method of claim 1, wherein the step of transferring the license and subscription information to the local access point comprises transferring the license and subscription information to a set top box.

6. The method of claim 1, wherein the method further comprises the step of authenticating a user's license and subscription information.

7. The method of claim 1, wherein the step of obtaining license and subscription information is done by securely storing information transferred from a set top box into the mobile communication device.

8. The method of claim 1, wherein the method further comprises the step of applying digital rights management to protect the content provided on the second network while promoting the sharing of content among users.

9. The method of claim 1, wherein the method further comprises the step of blocking additional content from being provided on the second network if such content is beyond the scope of the license.

10. A wireless communication device, comprising:
a transceiver; and
a processor coupled to the transceiver, wherein the processor is programmed to:
receive a license and subscription information over a first network for content available on a second network; and
transfer the license and subscription information via a short range communication link to a local access point device to authorize receipt of content on the second network if a network operator for the second network verifies the license.

11. The wireless communication device of claim 10, wherein the wireless communication device comprises a cellular phone, a satellite phone, a smart phone, a laptop computer, a personal digital assistant, or a two-way messaging device.

12. The wireless communication device of claim 10, wherein processor is programmed to obtain the license and subscription information by an over-the-air connection via a WiFi network, a Bluetooth connection, an RFID communication, an infrared link, a satellite link, a cellular communication link, or a wired communication link.

13. The wireless communication device of claim 10, wherein processor is programmed to transfer the license and subscription information via the short range communication link by transferring the license and subscription information via a Bluetooth connection, an RFID communication, an infrared link, or a wired link.

14. The wireless communication device of claim 10, wherein processor is programmed to transfer the license and subscription information to the local access point by transferring the license and subscription information to a set top box.

15. The wireless communication device of claim 10, wherein processor is further programmed to authenticate a user's license and subscription information.

16. The wireless communication device of claim 10, wherein processor is further programmed to apply digital rights management to protect the content provided on the second network while promoting the sharing of content among users.

17. The wireless communication device of claim 10, wherein processor is programmed to block additional content from being provided on the second network if such content is beyond the scope of the license.

18. A wireless communication system using a portable license, comprising:
a transceiver;
a local access point operatively coupled to a wireless communication device having the transceiver; and
a processor coupled to the transceiver, wherein the processor is programmed to:
receive a license and subscription information over a first network for content available on a second network; and
transfer the license and subscription information via a short range communication link to the local access point device to authorize receipt of content on the second network if a network operator for the second network verifies the license.

19. The wireless communication system of claim 18, wherein the transceiver is a part of a cellular phone, a satellite phone, a smart phone, a laptop computer, a personal digital assistant, or a two-way messaging device.

20. The wireless communication system of claim 18, wherein the local access point is a set top box or a satellite radio receiver system.
